(19) United States
(12) Patent Application Publication
(10) Pub. No.: US 2008/0304514 A1
(43) Pub. Date: Dec. 11, 2008

(54) METHOD AND APPARATUS FOR COMMUNICATING WITH A HETEROGENEOUS TERMINAL

(75) Inventors: Pil-Soon CHOI, Anyang-si (KR); Chang-Yeul KWON, Yongin-si (KR); Ji-Sung OH, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/043,243

(22) Filed: Mar. 6, 2008

Related U.S. Application Data
(60) Provisional application No. 60/942,532, filed on Jun. 7, 2007.

(30) Foreign Application Priority Data
Aug. 1, 2007 (KR) 10-2007-0077438

(51) Int. Cl. H04L 29/08

(52) U.S. Cl. 370/466

(57) ABSTRACT

Provided are a method and apparatus for communicating with a heterogeneous terminal, more particularly, a method and apparatus for communicating with a heterogeneous terminal in which the communication between terminals using different modulation methods can be initialized by transmitting throughout a network a preamble with a waveform that is commonly used in the network. The apparatus includes a preamble-generation unit which generates a preamble having a plurality of sequences corresponding to a combination of a modulation method and a waveform that are to be applied to a packet; and a communication unit which attaches the preamble to the packet and then transmits the packet.

### CROSS-REFERENCE TO RELATED APPLICATION

This application claims priority from U.S. Provisional Application No. 60/942,532 filed on Jun. 7, 2007 in the United States Patent and Trademark Office, and Korean Patent Application No. 10-2007-0077438 filed on Aug. 1, 2007 in the Korean Intellectual Property Office, the disclosures of which are incorporated herein by reference in their entirety.

### BACKGROUND OF THE INVENTION

1. Field of the Invention

The present invention relates to a method and apparatus for communicating with a heterogeneous terminal, and, more particularly, to a method and apparatus for communicating with a heterogeneous terminal in which the communication between terminals using different modulation methods can be initialized by transmitting between the terminals a preamble with a waveform that is commonly used in a network.

2. Description of the Related Art

As networks become wireless and the demand for transmission of large multimedia data increases, there is a need for an effective transmission method in a wireless network environment. In particular, the need for various home devices to wirelessly transmit high-quality videos, such as digital video disk (DVD) images or high definition television (HDTV) images, is growing.

The IEEE 802.15.3c Task Group is developing a technological standard for transmitting large volumes of data over a wireless home network. The technological standard “millimeter wave (mmWave)” uses an electromagnetic wave having a physical wavelength of a millimeter (i.e., an electromagnetic wave in the frequency band of 30-300 GHz) to transmit large volumes of data. This frequency band, which is an unlicensed band, has conventionally been used by communication service providers for limited purposes, such as observing electromagnetic waves or preventing vehicle collision.

FIG. 1 is a diagram which compares the frequency bands of the IEEE 802.11 series of standards and mmWave. Referring to FIG. 1, the IEEE 802.11b or IEEE 802.11g standard uses a carrier frequency of 2.4 GHz, and has a channel bandwidth of approximately 20 MHz. In addition, the IEEE 802.11a or IEEE 802.11n standard uses a carrier frequency of 5 GHz and has a channel bandwidth of approximately 20 MHz. In contrast, mmWave uses a carrier frequency of 60 GHz and has a channel bandwidth of approximately 0.5-2.5 GHz. Therefore, mmWave has a far greater carrier frequency and channel bandwidth than the IEEE 802.11 series of standards. When a high-frequency signal (a millimeter wave) having a millimeter wavelength is used, a very high transmission rate of several Gbps can be achieved. Since the size of an antenna can also be reduced to less than 1.5 mm, a single chip having such an antenna included therein can be implemented. Furthermore, interference between devices can be reduced due to a very high attenuation ratio of high-frequency signals in the air.

A method of transmitting uncompressed audio or video data (hereinafter, referred to as “uncompressed AV data”) between wireless devices using a high bandwidth of a millimeter wave has recently been studied. Compressed AV data is generated after lossy compression processes such as motion compensation, discrete cosine transform (DCT), quantization, and variable length coding (VLC) processes. In so doing, portions of the compressed AV data, to which human visual and auditory senses are less sensitive, are removed. In contrast, uncompressed AV data includes digital values indicating pixel components, for example, red (R), green (G) and blue (B) components.

Devices that transmit/receive data in such a network environment may be classified according to the types of modulation methods that they use. Devices using different modulation methods cannot transmit/receive data to/from each other. Thus, when devices using different modulation methods share the same network, a number of problems regarding the allocation and the use of frequency bands arises.

That is, devices in a network are allowed to use a frequency band according to a predetermined schedule. However, if the devices use different modulation methods from one another, they may not be able to properly recognize scheduling information, and may thus cause interference to the use of the frequency band by other devices.

Therefore, it is necessary to develop a way to enable devices in a network to make smooth use of the network when the devices use different modulation methods.

### SUMMARY OF THE INVENTION

Aspects of the present invention provide initializing of the communication between terminals that use different modulation methods by transmitting between the terminals a preamble with a waveform that is commonly used in a network.

However, aspects of the present invention are not restricted to the one set forth herein. The above and other aspects of the present invention will become more apparent to one of daily skill in the art to which the present invention pertains by referencing the detailed description of the present invention given below.

According to an aspect of the present invention, there is provided an apparatus for communicating with a heterogeneous terminal, the apparatus including: a preamble-generation unit which generates a preamble having a plurality of sequences corresponding to a combination of a modulation method and a waveform that are to be applied to a packet; and a communication unit which attaches the preamble to the packet and then transmits the packet.

According to another aspect of the present invention, there is provided an apparatus for communicating with a heterogeneous terminal, the apparatus including: a communication unit which receives a packet distributed throughout a network; and a preamble analysis unit which determines a modulation method and a waveform applied to the packet based on a pattern of arrangement of a plurality of sequences in a preamble of the packet.

According to another aspect of the present invention, there is provided a method of communicating with a heterogeneous terminal, the method including: generating a preamble having a plurality of sequences corresponding to a combination of a modulation method and a waveform that are to be applied to a packet; and attaching the preamble to the packet and transmitting it.

According to another aspect of the present invention, there is provided a method of communicating with a heterogeneous terminal, the method including: receiving a packet distributed throughout a network; and determining a modulation method and a waveform applied to the packet based on a pattern of arrangement of a plurality of sequences in a preamble of the packet.

### BRIEF DESCRIPTION OF THE DRAWINGS

The above and other aspects and features of the present invention will become apparent by describing in detail exemplary embodiments thereof with reference to the attached drawings, in which:

FIG. 1 compares frequency bands of the IEEE 802.11 series of standards and the millimeter Wave (mmWave) standard;

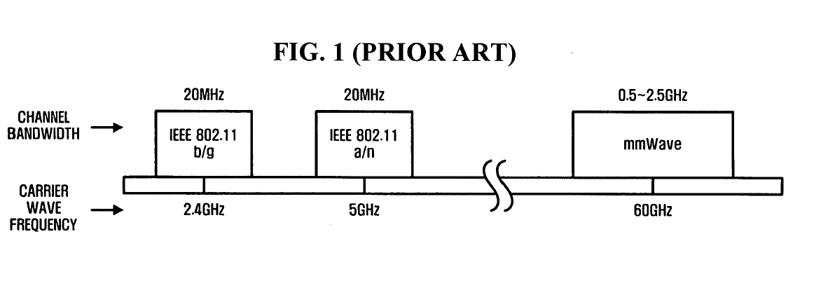

FIG. 2 illustrates the coexistence of a plurality of heterogeneous terminals in a network according to an embodiment of the present invention;

FIG. 3 illustrates the transmission of data between heterogeneous terminals according to an embodiment of the present invention;

FIG. 4 illustrates the format of a packet according to an embodiment of the present invention;

FIG. 5 illustrates a block diagram of an apparatus for communicating with a heterogeneous terminal according to an embodiment of the present invention;

FIG. 6 illustrates a block diagram of an apparatus for communicating with a heterogeneous terminal according to another embodiment of the present invention;

FIG. 7 illustrates the format of a preamble of the packet illustrated in FIG. 2;

FIG. 8 illustrates two sequences having opposite phases, according to an embodiment of the present invention;

FIG. 9 illustrates a sequence pattern table according to an embodiment of the present invention;

FIG. 10 illustrates a flowchart of an operation of a packet-transmission apparatus according to an embodiment of the present invention; and

FIG. 11 illustrates a flowchart of an operation of a packet-reception apparatus according to an embodiment of the present invention

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art. Like reference numerals in the drawings denote like elements, and thus their description will be omitted.

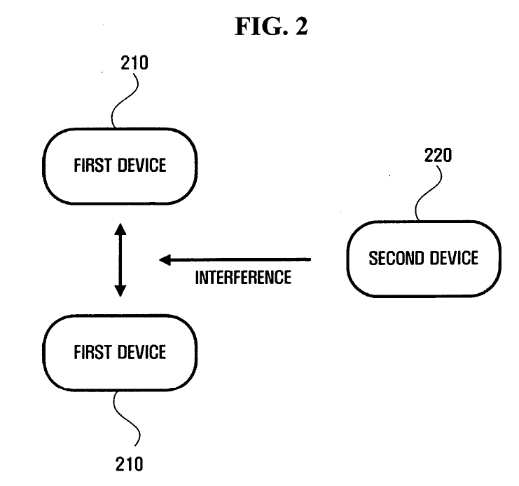

FIG. 2 illustrates a plurality of heterogeneous terminals in a network according to an embodiment of the present invention, and, particularly, how a terminal notifies another terminal of its existence.

A plurality of terminals that coexist in a network may be classified by their modulation methods. For example, a first type device (210) has a low complexity level, consumes less power and can be realized at relatively low cost, and a second type device (220) has a high complexity level, consumes much power, and is realized at high cost.

A first type device (210) can transmit/receive packets in a relatively good network environment such as an Additive White Gaussian Noise (AWGN) channel environment or a Line Of Site (LOS) channel environment. A first type device (210) uses a relatively simple modulation method and a relatively simple waveform. A first type device (210) is mostly a portable application.

In contrast, a second type device (220) can transmit/receive packets even in a relatively poor network environment such as a Non Line Of Site (NLOS) channel environment. A second type device (220) uses a relatively complicated modulation method and a relatively complicated waveform. A second type device (220) is mostly a fixed CE device.

Since a first type device (210) and a second type device (220) use different modulation methods and different waveforms, they may not be able to readily communicate with each other. In addition, a second type device (220) may cause interference in the transmission of data between a pair of first type devices (210) through a predetermined frequency band by using the predetermined frequency band, as illustrated in FIG. 2.

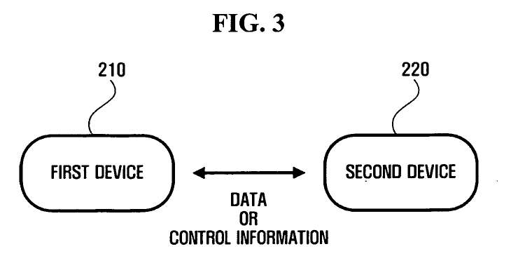

Thus, it is necessary to perform a network initialization operation in order to enable the transmission of data or control information between heterogeneous terminals, as illustrated in FIG. 3. In the present embodiment, a first type device (210) and a second type device (220) modulate part of a packet for information about their modulation methods and waveforms using the predetermined common modulation method and waveform, and distribute the modulated packet throughout a network in order to prevent band interference and initialize the network.

As a result, a receiving device which receives the modulated packet may be able to recognize the existence of a transmitting device and the modulation method and the waveform of the transmitting device. Then, the receiving device may communicate with the transmitting device by switching its modulation method and waveform to those of the transmitting device.

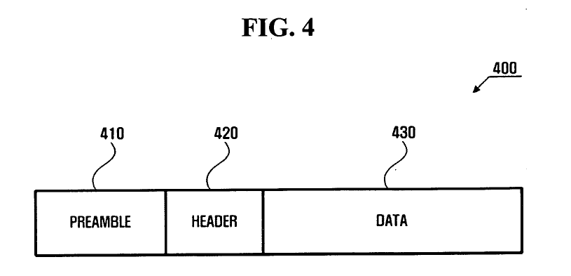

FIG. 4 illustrates a packet 400 according to an embodiment of the present invention. Referring to FIG. 4, the packet 400 includes a preamble 410, a header field 420 and a data field 430.

When devices using different modulation methods coexist in a network, a number of problems regarding the allocation and the use of frequency bands may arise, and, thus, it is necessary for such heterogeneous devices in the same network to reciprocally detect one another. Reciprocal detection methods include a beacon-detection method, a preamble-detection method and an energy-detection method.

The beacon-detection method involves inserting information necessary for allocating a frequency band into a data field of a beacon packet, distributing the beacon packet throughout a network, and thus limiting the use of a predetermined frequency band by devices in the network. The beacon-detection method can impose restrictions on the use of a predetermined frequency band during a predetermined time period and can thus provide a more powerful scheduling function compared to the preamble-detection method and the energy-detection method. However, the beacon-detection method requires the distribution of a common beacon throughout a network in order for the beacon to be recognized by all devices in the network. That is, a preamble, a header field and a data field of a beacon packet are all required to include appropriate information, and a modulation method and a waveform used to produce the beacon packet must be shared between all stations in a network.

The preamble-detection method involves distributing a preamble having a predefined waveform throughout a network and thus notifying all devices in the network of the existence of a predetermined device using a predetermined frequency band. The preamble-detection method requires the distribution of a common preamble. That is, only a preamble of a packet is required to include appropriate information, and a modulation method and a waveform used to produce the preamble must be shared between all stations in a network.

The energy-detection method enables devices in a network to determine the existence of signals. Specifically, when a device distributes an arbitrary packet throughout a network in an attempt to use a predetermined frequency band, the energy-detection method imposes restrictions on the use of the predetermined frequency band by allowing other devices in the network to simply detect the arbitrary packet without interpretation of the arbitrary packet. Since the energy-detection method does not involve distributing predetermined information but involves allowing devices in a network to determine the existence of signals, the energy-detection method does not require the distribution of common packets. However, the energy-detection method can only provide a less powerful scheduling function compared to the beacon-detection method and the preamble-detection method.

A first type device (210) or a second type device (220) of this invention configures a packet 400 using the preamble-detection method, and transmits the packet 400. The first type device (210) or the second type device (220) announces its modulation method and waveform using a pattern of arrangement of a sequence group including one or more sequences in a preamble 410 of the packet 400. The modulation method and the waveform used by the first type device (210) or the second type device (220) are a modulation method and a waveform, respectively, applied to a header field 420 and a data field 430 of the packet 400.

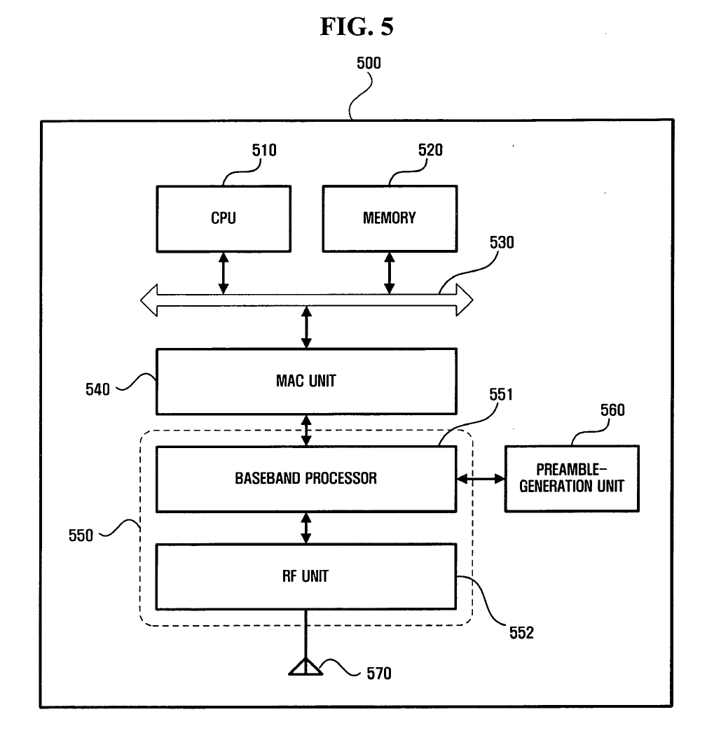

FIG. 5 illustrates a block diagram of an apparatus 500 for communicating with a heterogeneous terminal according to an embodiment of the present invention. Referring to FIG. 5, the apparatus 500 includes a central processing unit (CPU) 510, a memory 520, a media access control (MAC) unit 540, a communication unit 550, and a preamble-generation unit 560. The apparatus 500 transmits a packet 400 including a preamble 410 according to an embodiment of the present invention, and thus will hereinafter be referred to as the packet-transmission apparatus 500.

The CPU 510 controls a number of elements of the packet-transmission apparatus 500 which are connected to a bus 530. The CPU 510 may process received data, i.e., received MAC Service Data Unit (MSDU), provided by the MAC unit 540. Alternatively, the CPU 510 may generate data to be transmitted, i.e., an MSDU, and provide the generated MSDU to the MAC unit 540.

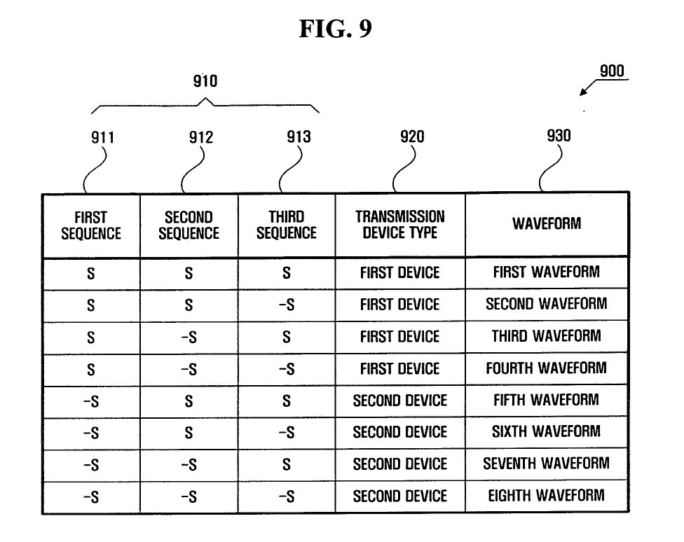

The memory 520 stores a sequence pattern table. The sequence pattern table will be described later in further detail with reference to FIG. 9. The memory 520 is a module such as a hard disc, an optical disc, a flash memory, a Compact Flash (CF) card, a Secure Digital (SD) card, a Smart Media (SM) card, a MultiMedia Card (MMC) card or a memory stick to/from which data can be input/output. The memory 520 may be included in the packet-transmission apparatus 500 or in an external apparatus.

The preamble-generation unit 560 generates a preamble 410 including a sequence group corresponding to the combination of a predetermined modulation method and a predetermined waveform used by the packet-transmission apparatus 500. The preamble-generation unit 560 may arrange a sequence group, including one or more sequences, in the preamble 410 using a sequence-arrangement pattern corresponding to the combination of the predetermined modulation method and the predetermined waveform used by the packet-transmission apparatus 500. The sequence group may include one or more sequences having the same phase or different phases.

For example, assuming that there are first and second sequences S and −S having a phase difference of 180 degrees therebetween, the preamble 410 may include a combination of a number of first sequences S and a number of second sequences −S.

A sequence combination may be identified by the types of sequences included therein and the pattern of the arrangement of the sequences. The preamble-generation unit 560 may generate the preamble 410 with reference to the sequence pattern table present in the memory 520. That is, the preamble-generation unit 560 may configure a sequence combination corresponding to the combination of a modulation method and a waveform used by the communication unit 550, and insert the sequence combination in the preamble 410. The modulation method and the waveform used by the communication unit 550 may be a modulation method and a waveform, respectively, applied to a header field 420 and a data field 430 of a packet 400.

The communication unit 550 adds the preamble 410 generated by the preamble-generation unit 560 to the header field 420 and the data field 430, and transmits the packet 400. The communication unit 550 may transmit the—preamble 410 using a modulation method and a waveform that are commonly used in a network of the packet-transmission apparatus 500. Thus, all terminals in the network of the packet-transmission apparatus 500 may be able to recognize the preamble 410 transmitted by the communication unit 550.

The communication unit 550 includes a baseband processor 551 and a radio frequency (RF) unit 552, and is connected to an antenna 570. The antenna 570 can transmit/receive low-frequency wireless signals with no directivity or high-frequency wireless signals with directivity. A frequency band of a communication channel established by the RF unit 552 ranges from as low as 2.4 GHz or 5 GHz to as high as 60 GHz.

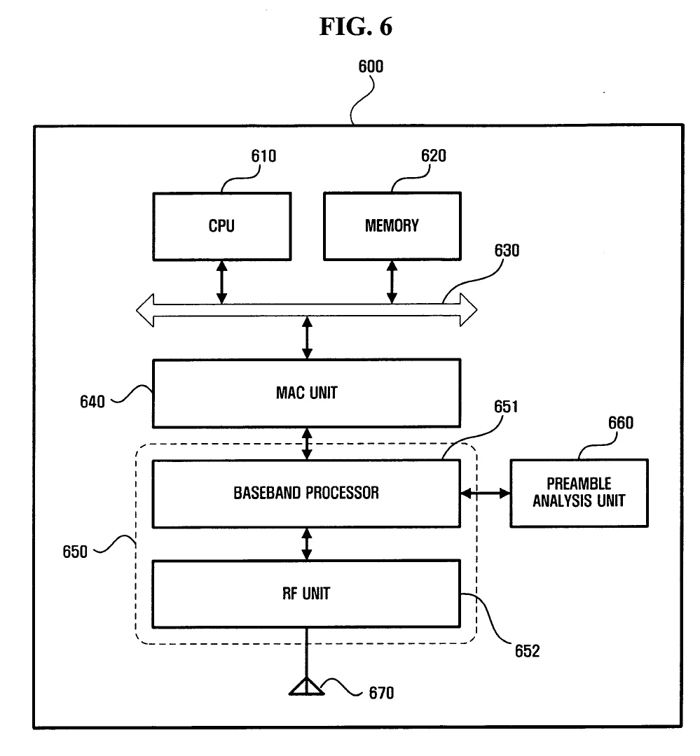

FIG. 6 illustrates a block diagram of an apparatus 600 for communicating with a heterogeneous terminal according to another embodiment of the present invention. Referring to FIG. 6, the apparatus 600 includes a CPU 610, a memory 620, a MAC unit 640, a communication unit 650, and a preamble analysis unit 660. The apparatus 600 receives a packet 400 including a preamble 410 according to an embodiment of the present invention, and thus will hereinafter be referred to as the packet-reception apparatus 600.

The CPU 610 controls a number of elements of the packet-reception apparatus 600 which are connected to a bus 630. The CPU 610 may process received data, i.e., a received MSDU, provided by the MAC unit 640. Alternatively, the CPU 610 may generate data to be transmitted, i.e., an MSDU, and provide the generated MSDU to the MAC unit 640.

The memory 620 stores a sequence pattern table. The memory 620 is a module such as a hard disc, an optical disc, a flash memory, a CF card, an SD card, an SM card, an MMC card or a memory stick which data can be input to and output from. The memory 620 may be included in the packet-reception apparatus 600 or in an external apparatus.

The communication unit 650 receives a packet 400 distributed throughout a network of the packet-reception apparatus 600. The communication unit 650 may receive the preamble 410 using a modulation method and a waveform that are commonly used in the network of the packet-reception apparatus 600. Thus, the communication unit 550 may receive a preamble transmitted by any terminal in the network of the packet-reception apparatus 600.

The communication unit 650 includes a baseband processor 651 and an RF unit 652, and is connected to an antenna 670. The antenna 670 can transmit/receive low-frequency wireless signals with no directivity or high-frequency wireless signals with directivity. A frequency band of a communication channel established by the RF unit 652 ranges from as low as 2.4 GHz or 5 GHz to as high as 60 GHz.

The preamble analysis unit 660 determines the modulation method and the waveform used to produce the packet 400 based on the pattern of the arrangement of sequences in a preamble 410 of the packet 400. That is, the preamble analysis unit 660 determines the modulation method and the waveform applied to a header field 420 and a data field 430 of the packet 400 by the packet-transmission apparatus 500.

The preamble analysis unit 660 may reference the sequence pattern table present in the memory 620 to determine the modulation method and the waveform applied to the header field 420 and the data field 430 of the packet 400 by the packet-transmission apparatus 500.

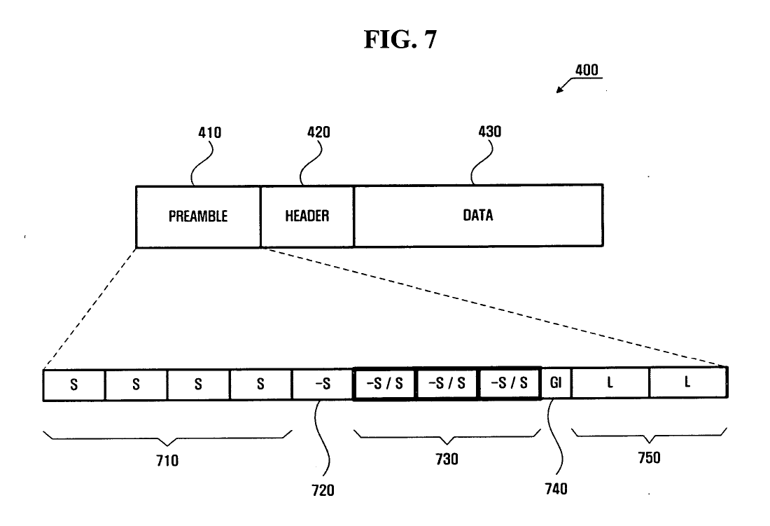

FIG. 7 illustrates the format of the preamble 410 of the packet 400 illustrated in FIG. 2. Referring to FIG. 7, the preamble 410 includes one or more synchronization sequences 710, a beginning indicator sequence 720, a sequence group 730, a guard interval (GI) sequence 740, and long sequences 750.

The synchronization sequences 710 are used to synchronize the transmission/reception of the packet 400. The synchronization sequences 710 may include a group of short sequences. In order to secure high synchronization efficiency, the synchronization sequences 710 may include a number of short sequences of the same type.

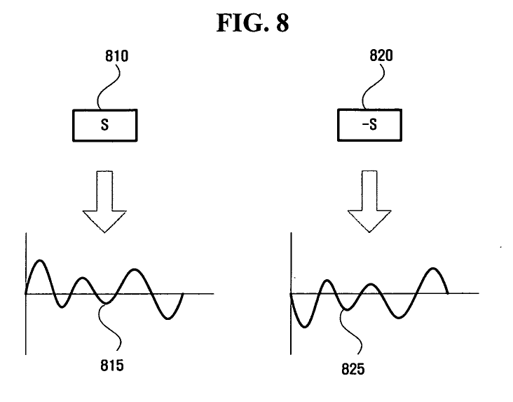

The beginning indicating sequence 720 indicates the beginning of the sequence group 730. The preamble analysis unit 660 of the packet-reception apparatus 600 may determine the location of the sequence group 730 based on the beginning indicator sequence 720. The beginning indicator sequence 720 may be different from the synchronization sequences 710, and thus may be easily distinguished. For example, the beginning indicator sequence 720 may have a phase difference of 180 degrees with the short sequence of the synchronization sequences 710. FIG. 8 illustrates a pair of sequences having a phase difference of 180 degrees therebetween. Referring to FIG. 8, a first sequence S (810) corresponds to a first waveform 815, and a second sequence −S (820) which has a phase difference of 180 degrees with the first sequence S (810) corresponds to a second waveform 825.

Referring to FIG. 7, the sequence group 730 may include one or more sequences of the same type or different types. The sequences in the sequence group 730 may have the same phase or different phases.

The pattern of the sequence group 730 may represent the modulation method and the waveform applied to the header field 420 and the data field 430 by the communication unit 550 of the packet-transmission apparatus 500. Since a sequence pattern table showing the correspondence between a plurality of sequence-arrangement patterns, a plurality of modulation methods and a plurality of waveforms is shared between the packet-transmission apparatus 500 and the pattern reception apparatus 600, the pattern reception apparatus 600 may determine a modulation method and a waveform used by the packet-transmission apparatus 500 based on the pattern of the sequence group 730.

The GI sequence 740 is inserted between the sequence group 730 and the long sequences 750, and prevents the sequence group 730 and the long sequences 750 from interfering with each other.

The long sequences 750 are used to perform channel estimation and fine frequency offset estimation.

FIG. 9 illustrates a sequence pattern table 900. Referring to FIG. 9, the sequence pattern table 900 includes a sequence group field 910, a transmission device type field 920, and a waveform field 930.

The sequence group field 910 is divided into first, second and third sequence fields 911, 912, and 913. The first, second and third sequence fields 911, 912, and 913 present first, second and third sequences, respectively, of each of a plurality of sequence groups. Each of the sequence groups presented by the sequence group field 910 is a linear arrangement of three sequences of the same type or different types. Specifically, referring to FIG. 9, each of the sequence groups presented by the sequence group field 910 is an ordered collection of three sequences taken from the set of two sequences: a first sequence S and a sequence −S having a phase difference of 180 degrees with the first sequence S. However, the present invention is not restricted to this. That is, the present invention can be applied to various types of sequences, and the number of sequences in a sequence group may vary.

The transmission device type field 920 presents two types of transmission devices. Specifically, the transmission device type field 920 is used to determine whether the pattern transmission apparatus 500 is a first type device (210) or a second type device (220). However, the present invention is not restricted to this. That is, the present invention can be applied to various types and various number of transmission devices whose modulation method is different.

The waveform field 930 presents a plurality of waveforms used by each of transmission devices specified in the transmission device type field 920. That is, the waveform field 930 presents a plurality of waveforms used to transmit a header field 420 and a data field 430 of a packet 400.

The packet-reception apparatus 600 may determine the modulation method and the waveform used by the packet-transmission apparatus 500 with reference to the sequence pattern table 900. For example, if the pattern of the arrangement of three sequences in a sequence group received from the packet-transmission apparatus 500 is (S, S, −S), then the packet-reception apparatus 600 determines that the packet-transmission apparatus 500 is a first type device (210), and that the waveform used by the packet-transmission apparatus 500 is a second waveform. In this manner, the packet-reception apparatus 600 may recognize the existence of the packet-transmission apparatus 500, and may transmit data to and receive data from the packet-transmission apparatus 500 by using the same modulation method and the same waveform as the modulation method and the waveform used by the packet-transmission apparatus 500.

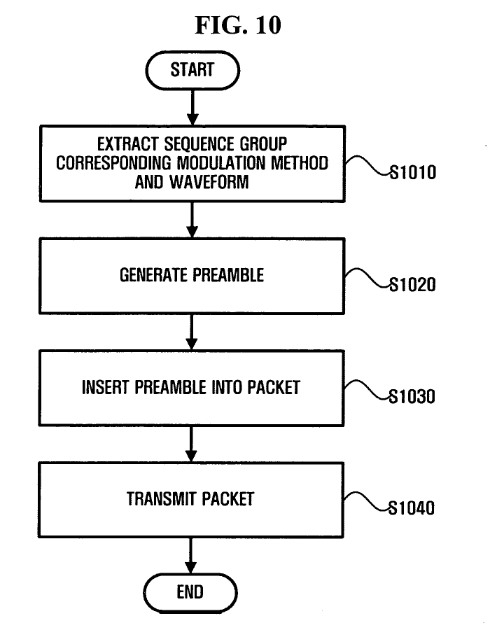

FIG. 10 illustrates a flowchart of an operation of the packet-transmission apparatus 500 according to an embodiment of the present invention. Referring to FIG. 10, the preamble-generation unit 560 of the packet-transmission apparatus 500 extracts a sequence group corresponding to the combination of the modulation method and the waveform used by the communication unit 560 with reference to the sequence pattern table 900 present in the memory 520 (S1010). The extracted sequence group includes one or more sequences having the same phase or different phases.

The preamble-generation unit 560 generates a preamble 410 by inserting the extracted sequence group into a preamble (S1020).

The preamble 410 is transmitted to the communication unit 550. Then, the communication unit 550 inserts the preamble 410 into a packet (S1030), and transmits the packet (S1040). The packet transmitted by the communication unit 550 includes the preamble 410, a header field 420 and a data field 430. The communication unit 550 transmits the preamble 410 using a predefined modulation method and a predefined waveform. The predefined modulation method and the predefined waveform are a modulation method and a waveform, respectively, commonly used by all devices in a network, and thus, the devices in the network may all be able to recognize the preamble 410 transmitted by the communication unit 550.

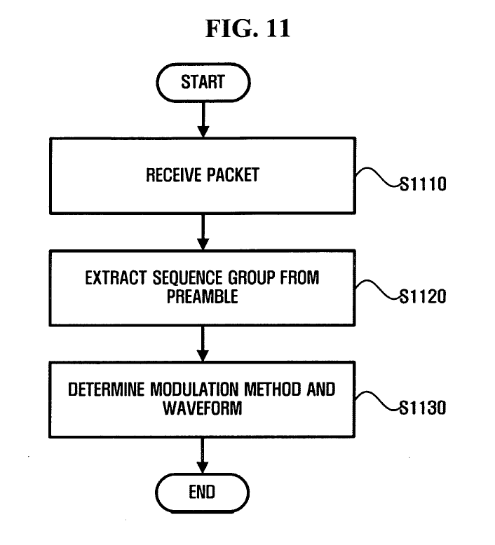

FIG. 11 illustrates a flowchart of an operation of the packet-reception apparatus 600 according to an embodiment of the present invention. Referring to FIG. 11, the communication unit 650 of the packet-reception apparatus 600 receives a packet 400 distributed throughout a network (S1110). The communication unit 650 may receive the packet using a predefined modulation method and a predefined waveform corresponding to a preamble 410 of the packet 400.

The preamble 410 of the packet 400 is transmitted to the preamble analysis unit 660. Then, the preamble analysis unit 660 extracts a sequence group 730 from the preamble 410 (S1120). The preamble 410 includes one or more synchronization sequences 710, a beginning indicator sequence 720 and the sequence group 730. The preamble analysis unit 660 may extract the sequence group from the preamble 410 with reference to the location of the beginning indicator sequence 720.

The preamble analysis unit 660 determines a modulation method and a waveform corresponding to the sequence group 730 with reference to the sequence pattern table 900 present in the memory 620 (S 1130). The identified modulation method and the waveform corresponding to the sequence group 730 are the modulation method and the waveform, respectively, used by the packet-transmission apparatus 500. Thus, the packet-reception apparatus 600 may recognize the existence of the packet-transmission apparatus 500 based on the result of the determination performed by the preamble analysis unit 660, and may thus transmit data to and receive from the packet-transmission apparatus 500 by using the same communication method as that of the packet-transmission apparatus 500.

As described above, according to the present invention, a preamble having a modulation method and a waveform that are commonly used by heterogeneous terminals is transmitted in order to initialize the communication between the heterogeneous terminals. Therefore, it is possible to enable terminals in a network to communicate with each other regardless of whether they use different modulation methods.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for communicating with a heterogeneous terminal, comprising:
a preamble-generation unit which generates a preamble having a plurality of sequences corresponding to a combination of a modulation method and a waveform that are to be applied to a packet; and
a communication unit which attaches the preamble to the packet and then transmits the packet.

2. The apparatus of claim 1, wherein the communication unit transmits the preamble using a modulation method and a waveform that are commonly used in a network.

3. The apparatus of claim 1, wherein the preamble-generation unit arranges the sequences which are of the same type or different types in the preamble using a sequence-arrangement pattern corresponding to the combination of the modulation method and the waveform that are to be applied to the packet.

4. The apparatus of claim 3, wherein each of the sequences has the same phase or different phase to each other.

5. The apparatus of claim 3, further comprising a memory which stores the sequence-arrangement pattern.

6. The apparatus of claim 1, wherein the preamble further comprises
one or more synchronization sequences which are used to synchronize the transmission or reception of the packet; and
a beginning indicator sequence which is used to indicate the beginning of the plurality of sequences.

7. An apparatus for communicating with a heterogeneous terminal, comprising:
a communication unit which receives a packet distributed throughout a network; and
a preamble analysis unit which determines a modulation method and a waveform applied to the packet based on a pattern of arrangement of a plurality of sequences in a preamble of the packet.

8. The apparatus of claim 7, wherein the communication unit receives the preamble using a modulation method and a waveform that are commonly used in the network.

9. The apparatus of claim 7, wherein each of the sequences has the same phase or different phase to each other.

10. The apparatus of claim 7, further comprising a memory which stores the sequence-arrangement pattern.

11. The apparatus of claim 7, wherein the preamble further comprises one or more synchronization sequences which are used to synchronize the transmissionor reception of the packet; and
a beginning indicator sequence which is used to indicate the beginning of the plurality of sequences.

12. A method of communicating with a heterogeneous terminal, comprising:
generating a preamble having a plurality of sequences corresponding to a combination of a modulation method and a waveform that are to be applied to a packet;
attaching the preamble to the packet; and
transmitting the packet.

13. The method of claim 12, wherein the transmitting of the packet comprises transmitting the preamble using a modulation method and a waveform that are commonly used in a network.

14. The method of claim 12, wherein the generating of the preamble comprises arranging the sequences which are of the same type or different types in the preamble using a sequence-arrangement pattern corresponding to the combination of the modulation method and the waveform that are to be applied to the packet.

15. The method of claim 14, wherein each of the sequences has the same phase or different phase to each other.

16. The method of claim 12, wherein the preamble further comprises one or more synchronization sequences which are used to synchronize the transmission or reception of the packet; and
a beginning indicator sequence which is used to indicate the beginning of the plurality of sequences.

17. A method of communicating with a heterogeneous terminal, comprising:
receiving a packet distributed throughout a network; and
determining a modulation method and a waveform applied to the packet based on a pattern of arrangement of a plurality of sequences in a preamble of the packet.

18. The method of claim 17, wherein the receiving of the packet comprises receiving the preamble using a modulation method and a waveform that are commonly used in the network.

19. The method of claim 17, wherein each of the sequences has the same phase or different phase to each other.

20. The method of claim 17, wherein the preamble further comprises one or more synchronization sequences which are used to synchronize the transmission or reception of the packet; and
a beginning indicator sequence which is used to indicate the beginning of the plurality of sequences.

21. The apparatus of claim 6, wherein each of the synchronization sequences is a same type and the beginning indicator sequence is a different type.

22. The apparatus of claim 11, wherein each of the synchronization sequences is a same type and the beginning indicator sequence is a different type.

23. The method of claim 16, wherein each of the synchronization sequences is a same type and the beginning indicator sequence is a different type.

24. The method of claim 20, wherein each of the synchronization sequences is a same type and the beginning indicator sequence is a different type.
